(19) United States
(12) Patent Application Publication
(10) Pub. No.: US 2019/0024493 A1
(43) Pub. Date: Jan. 24, 2019

(54) SYSTEM AND METHOD FOR DOWNHOLE DRILL ESTIMATION USING TEMPORAL GRAPHS FOR AUTONOMOUS DRILL OPERATION

(71) Applicant: HRL Laboratories, LLC, Malibu, CA (US)

(72) Inventors: Samuel D. Johnson, Santa Monica, CA (US); Brian N. Limketkai, Santa Monica, CA (US); David J. Huber, Calabasas, CA (US); Rajan Bhattacharyya, Sherman Oaks, CA (US)

(21) Appl. No.: 16/032,826

(22) Filed: Jul. 11, 2018

Related U.S. Application Data
(60) Provisional application No. 62/531,191, filed on Jul. 11, 2017.

(51) Int. Cl. E21B 44/00; E21B 7/00; G06F 15/18

(52) U.S. Cl. CPC E21B 44/00; G06F 15/18; E21B 7/00

(57) ABSTRACT

Described is a system for determining the current state of a drill using downhole sensors. The system includes a sensor suite mounted on a drill string proximate a drill bit and a computer mounted on the drill string proximate the sensor suite. The computer includes a trained classifier and is operable for performing operations of receiving online sensor data from the sensor suite; and classifying the drill bit as being in one of a plurality of pre-trained drill states based on the online sensor data. A drill bit controller can then be used to modify the operation of the drill bit based on the drill state classification.

### CROSS-REFERENCE TO RELATED APPLICATIONS

This application claims the benefit of and is a non-provisional patent application of U.S. Provisional Application No. 62/531,191 filed on Jul. 11, 2017 the entirety of which is hereby incorporated by reference.

### BACKGROUND OF INVENTION

### (1) Field of Invention

The present invention relates to downhole drilling systems and, more specifically, to a system for autonomous downhole drilling using temporal graphs.

### (2) Description of Related Art

Drilling is a dangerous profession and the risk of bodily harm due to mechanical failures and breakages has led to a push for autonomous drilling operation that would allow the human operators to work relatively far away from the drill apparatus and minimally interact with the system. Ideally, an autonomous drilling apparatus would reduce errors caused by human operator fatigue from long work shifts and allow the drill to perform self-prognosis, determining when potentially dangerous or disastrous problems in the drill may occur long before a human operator might see the warning signs. However, an autonomous drill must also be able to know what it is currently doing (which may be different than what it was told to do or what it thinks it is doing).

At least one attempt has been made to develop an autonomous drilling system. Tichel et al. (see the List of Incorporated Literature References, Literature Reference No. 1) used wired drill pipe, high-speed downhole data, and closed-loop drilling automation technology to drive performance improvement across multiple wells. Their system used downhole sensors and wired drill pipe to send the sensor information to the surface where it was processed by algorithms in a computing environment on the surface that had control of the drilling environment. The automation in their system followed a “plan, do check, adjust” loop (i.e., closed loop control) which allowed control of the drill string vibration, automated steering, and control of the downhole weight-on-bit (WOB). However, a key disadvantage of their system is that it was not truly autonomous; the system required supervision and occasional input from a human operator. Further, their system was unable to detect faults and potential problems in the downhole. Thus, the role of the human operator was changed from an active to semi-passive participant that was not removed from the loop. All key decision making was still required to be done by the operator. Additionally, since the sensor data was not processed downhole, but rather communicated to the surface using the wired drill pipe, their method is limited by the costs associated with wired drill pipe.

Thus, a continuing need exist for system that can perform autonomous control of a drill using only downhole sensors. A need further exists for a system that can quickly adjust to changing downhole conditions to avoid potential fault conditions while simultaneously avoiding the costs associated with setups (like wired drill pipe, which are able to send sensor data to the surface for processing).

### SUMMARY OF INVENTION

Described is a system for determining the current state of a drill using downhole sensors. In various aspects, a sensor suite is mounted on a drill string proximate a drill bit. Further, a computer is mounted on the drill string proximate the sensor suite, the computer having a trained classifier and being operable for performing operations of receiving online sensor data from the sensor suite; and classifying the drill bit as being in one of a plurality of pre-trained drill states based on the online sensor data.

In another aspect, a drill bit controller is included. The drill bit controller has one or more processors and a memory, the memory being a non-transitory computer-readable medium having executable instructions encoded thereon, such that upon execution of the instructions, the one or more processors perform an operation of modifying the operation of the drill bit based on the drill state classification.

In yet another aspect, the classifier is trained based on offline sensor data recorded from previous drilling operations, the offline sensor data being converted into offline temporal graphs.

Further, the online sensor data is converted into an online temporal graph, with the drill state being classified by matching the online temporal graph with a collection of similar offline temporal graphs.

Additionally, the online temporal graph is created by associating degrees of freedom of each sensor in the sensor suite with its own node in the online temporal graph, providing a total of nine nodes. Further, edges exist between the nodes, such that weight of an edge (u, v)∈Eₜ between any two of the nodes in the online temporal graph is defined by a statistical relationship between sensors u and v at a given fixed-width temporal window in a time series.

Finally, the present invention also includes a computer program product and a computer implemented method. The computer program product includes computer-readable instructions stored on a non-transitory computer-readable medium that are executable by a computer having one or more processors, such that upon execution of the instructions, the one or more processors perform the operations listed herein. Alternatively, the computer implemented method includes an act of causing a computer to execute such instructions and perform the resulting operations.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a block diagram depicting the components of a system according to various embodiments of the present invention;

FIG. 2 is an illustration of a computer program product embodying an aspect of the present invention;

FIG. 3A is a graph depicting sensor array signals for a “Drill Slide” state;

FIG. 3B is a graph depicting sensor array signals for a “Drill Rotate” state;

FIG. 4 is an illustration depicting the evolution of edge weights over time, showing in a temporal graph that the number of vertices remains constant, but the weights of the edges between them are allowed to change;

FIG. 5 is a histogram of K-means clustering on feature vectors;

FIG. 6 is a histogram of drill states;

FIG. 7 is a histogram of classification errors in folds;

FIG. 8 is an illustration depicting both offline and online components of the system according to various embodiments of the present invention; and

FIG. 9 is a block diagram depicting control of a device according to various embodiments.

### DETAILED DESCRIPTION

The present invention relates to downhole drilling systems and, more specifically, to a system for autonomous downhole drilling using temporal graphs. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of aspects. Thus, the present invention is not intended to be limited to the aspects presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Before describing the invention in detail, first a list of cited references is provided. Next, a description of the various principal aspects of the present invention is provided. Subsequently, an introduction provides the reader with a general understanding of the present invention. Finally, specific details of various embodiment of the present invention are provided to give an understanding of the specific aspects.

### (1) LIST OF INCORPORATED LITERATURE REFERENCES

The following references are cited throughout this application. For clarity and convenience, the references are listed herein as a central resource for the reader. The following references are hereby incorporated by reference as though fully set forth herein. The references are cited in the application by referring to the corresponding literature reference number, as follows:
1. Trichel, D. K., Isbell, M., Brown, B. Flash, M., McRay, M., Nieto, J., & Fonseca, I. (2016). “Using Wired Drill Pipe, High-Speed Downhole Data, and Closed Loop Drilling Automation Technology to Drive Performance Improvement Across Multiple Wells in the Bakken,” In IADC/SPE Drilling Conference and Exhibition. Society of Petroleum Engineers.
2. Bishop, Christopher M. (2006) “Pattern Recognition and Machine Learning,” Information Sciences and Statistics. Springer-Verlag, New York 2006, pages 242-428.

### (2) PRINCIPAL ASPECTS

Various embodiments of the invention include three “principal” aspects. The first is a system for autonomous downhole drilling. The system is typically in the form of a computer system operating software or in the form of a “hard-coded” instruction set. This system may be incorporated into a wide variety of devices that provide different functionalities. The second principal aspect is a method, typically in the form of software, operated using a data processing system (computer). The third principal aspect is a computer program product. The computer program product generally represents computer-readable instructions stored on a non-transitory computer-readable medium such as an optical storage device, e.g., a compact disc (CD) or digital versatile disc (DVD), or a magnetic storage device such as a floppy disk or magnetic tape. Other, non-limiting examples of computer-readable media include hard disks, read-only memory (ROM), and flash-type memories. These aspects will be described in more detail below.

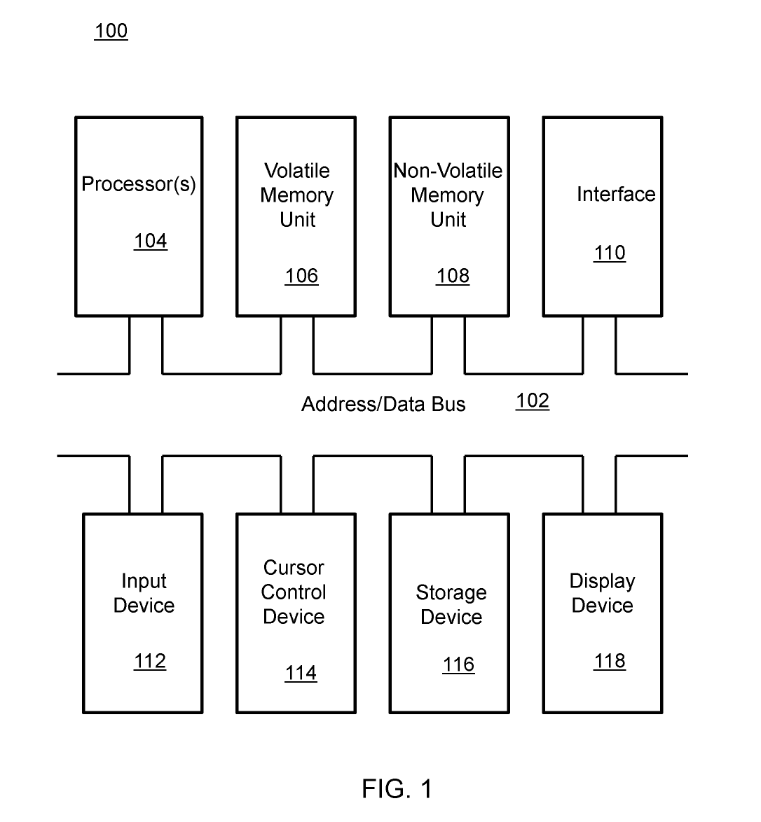

A block diagram depicting an example of a system (i.e., computer system 100) of the present invention is provided in FIG. 1. The computer system 100 is configured to perform calculations, processes, operations, and/or functions associated with a program or algorithm. In various aspects, the computer system 100 described herein is a computer as mounted on the drill string proximate the sensor suite and configured to perform the operations described herein. In one aspect, certain processes and steps discussed herein are realized as a series of instructions (e.g., software program) that reside within computer readable memory units and are executed by one or more processors of the computer system 100. When executed, the instructions cause the computer system 100 to perform specific actions and exhibit specific behavior, such as described herein.

The computer system 100 may include an address/data bus 102 that is configured to communicate information. Additionally, one or more data processing units, such as a processor 104 (or processors), are coupled with the address/data bus 102. The processor 104 is configured to process information and instructions. In an aspect, the processor 104 is a microprocessor. Alternatively, the processor 104 may be a different type of processor such as a parallel processor, application-specific integrated circuit (ASIC), programmable logic array (PLA), complex programmable logic device (CPLD), or a field programmable gate array (FPGA).

The computer system 100 is configured to utilize one or more data storage units. The computer system 100 may include a volatile memory unit 106 (e.g., random access memory (“RAM”), static RAM, dynamic RAM, etc.) coupled with the address/data bus 102, wherein a volatile memory unit 106 is configured to store information and instructions for the processor 104. The computer system 100 further may include a non-volatile memory unit 108 (e.g., read-only memory (“ROM”), programmable ROM (“PROM”), erasable programmable ROM (“EPROM”), electrically erasable programmable ROM “EEPROM”), flash memory, etc.) coupled with the address/data bus 102, wherein the non-volatile memory unit 108 is configured to store static information and instructions for the processor 104. Alternatively, the computer system 100 may execute instructions retrieved from an online data storage unit such as in “Cloud” computing. In an aspect, the computer system 100 also may include one or more interfaces, such as an interface 110, coupled with the address/data bus 102. The one or more interfaces are configured to enable the computer system 100 to interface with other electronic devices and computer systems. The communication interfaces implemented by the one or more interfaces may include wireline (e.g., serial cables, modems, network adaptors, etc.) and/or wireless (e.g., wireless modems, wireless network adaptors, etc.) communication technology.

In one aspect, the computer system 100 may include an input device 112 coupled with the address/data bus 102, wherein the input device 112 is configured to communicate information and command selections to the processor 100. In accordance with one aspect, the input device 112 is an alphanumeric input device, such as a keyboard, that may include alphanumeric and/or function keys. Alternatively, the input device 112 may be an input device other than an alphanumeric input device. In an aspect, the computer system 100 may include a cursor control device 114 coupled with the address/data bus 102, wherein the cursor control device 114 is configured to communicate user input information and/or command selections to the processor 100. In an aspect, the cursor control device 114 is implemented using a device such as a mouse, a track-ball, a track-pad, an optical tracking device, or a touch screen. The foregoing notwithstanding, in an aspect, the cursor control device 114 is directed and/or activated via input from the input device 112, such as in response to the use of special keys and key sequence commands associated with the input device 112. In an alternative aspect, the cursor control device 114 is configured to be directed or guided by voice commands.

In an aspect, the computer system 100 further may include one or more optional computer usable data storage devices, such as a storage device 116, coupled with the address/data bus 102. The storage device 116 is configured to store information and/or computer executable instructions. In one aspect, the storage device 116 is a storage device such as a magnetic or optical disk drive (e.g., hard disk drive (“HDD”), floppy diskette, compact disk read only memory (“CD-ROM”), digital versatile disk (“DVD”)). Pursuant to one aspect, a display device 118 is coupled with the address/data bus 102, wherein the display device 118 is configured to display video and/or graphics. In an aspect, the display device 118 may include a cathode ray tube (“CRT”), liquid crystal display (“LCD”), field emission display (“FED”), plasma display, or any other display device suitable for displaying video and/or graphic images and alphanumeric characters recognizable to a user.

The computer system 100 presented herein is an example computing environment in accordance with an aspect. However, the non-limiting example of the computer system 100 is not strictly limited to being a computer system. For example, an aspect provides that the computer system 100 represents a type of data processing analysis that may be used in accordance with various aspects described herein. Moreover, other computing systems may also be implemented. Indeed, the spirit and scope of the present technology is not limited to any single data processing environment. Thus, in an aspect, one or more operations of various aspects of the present technology are controlled or implemented using computer-executable instructions, such as program modules, being executed by a computer. In one implementation, such program modules include routines, programs, objects, components and/or data structures that are configured to perform particular tasks or implement particular abstract data types. In addition, an aspect provides that one or more aspects of the present technology are implemented by utilizing one or more distributed computing environments, such as where tasks are performed by remote processing devices that are linked through a communications network, or such as where various program modules are located in both local and remote computer-storage media including memory-storage devices.

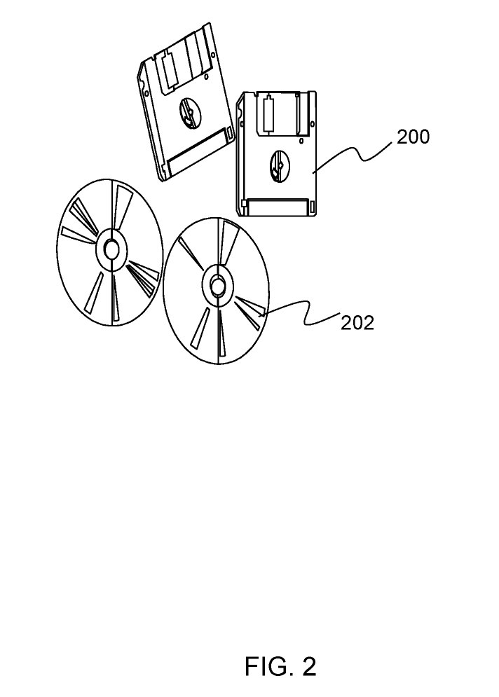

An illustrative diagram of a computer program product (i.e., storage device) embodying the present invention is depicted in FIG. 2. The computer program product is depicted as floppy disk 200 or an optical disk 202 such as a CD or DVD. However, as mentioned previously, the computer program product generally represents computer-readable instructions stored on any compatible non-transitory computer-readable medium. The term “instructions” as used with respect to this invention generally indicates a set of operations to be performed on a computer, and may represent pieces of a whole program or individual, separable, software modules. Non-limiting examples of “instruction” include computer program code (source or object code) and “hard-coded” electronics (i.e. computer operations coded into a computer chip). The “instruction” is stored on any non-transitory computer-readable medium, such as in the memory of a computer or on a floppy disk, a CD-ROM, and a flash drive. In either event, the instructions are encoded on a non-transitory computer-readable medium.

### (3) INTRODUCTION

As noted above, drilling is a dangerous profession that has led to a push for autonomous drilling. This disclosure addresses this issue by providing a system and method for autonomous downhole drilling using temporal graphs. The system creates a feature space from downhole sensor data from a sensor suite that can be used to determine the current drilling state at any given time using only the downhole data (i.e., with no assistance from the surface, and no human involvement). The feature space uses temporal graphs and operates on a sensor suite or array that is comprised of accelerometers and magnetometers to model the flow of information between sensors to determine the drill state which allows for autonomous control of the drill; a non-limiting example of such a sensor array or suite is that as disclosed in U.S. Patent Publication No. 2018/0080310, which is incorporated herein by reference. Unlike the prior art, the present system does not require human input at any time, which reduces the number of required drilling personnel and improves safety by moving existing personnel away from the drill string.

The system described herein allows drill rigs to automatically determine their current state using only the inputs from downhole sensors (zero input from the surface). The method is designed to operate downhole and in real-time to immediately determine the state of the drill and correct problems before they become unmanageable. This method can also be used to automatically forecast potential faults before they occur so that the drill can be shut down before damage to equipment or injury to onsite personnel occurs. The information provided by the present system may even be used to improve the quality of existing surface data by filling in gaps caused by missing or corrupt data and estimating unobservable and latent states, which may correspond to pre-failure or dangerous conditions that are not explicitly described in the engineering data. Thus, the system described herein includes several unique aspects, such as: (1) creating a feature space for downhole sensor data that determines the drill state using a standard classifier; (2) the feature space employs temporal graphs to model the flow of information over time in sensor data; (3) the system including the feature space and machine learning algorithms (i.e., SVM) can classify drill states using data from downhole sensors; (4) operation of the system does not require any human involvement at any time; and (5) the system can identify “hidden states” in the drill rig that cannot be quantified by current drill technology. These aspects eliminate the need for surface interaction and wired drill pipe (which is expensive); are faster than surface calculating methods (autonomy requires real-time operation); allow for identification of failure or other problems (through identification of hidden or latent states); and improve situational awareness and improve drilling performance.

In addition to being used to determine the state of the drill and control such a drill, the method described herein can also be used to improve the quality of surface data sets (by using machine learning algorithms and downhole data). By understanding the signals from the downhole sensors, one can fill in missing or corrupt regions in the surface data, where gaps are common. Additionally, a fused downhole-surface data representation can be used offline for data discovery tasks (i.e., “big data analytics”) and the estimation of unobservable variables and latent states, such as rate-of-penetration (ROP) and mechanical specific energy (MSE). Finally, this method can be expanded to perform anomaly detection and early warning indication using downhole data. This would improve autonomous guidance and warn of potential dangerous conditions that might result in damage to the drill head and injury to drilling personnel. This can be carried out with a combination of downhole state tracking, which will determine which states are misclassified due to unintended behavior, and by incorporating historical data from previous runs to predict future behavior of the system from the downhole data. Specific details regarding the present invention are provided below.

### (4) SPECIFIC DETAILS OF VARIOUS EMBODIMENTS

As noted above, this disclosure provides a system for autonomous downhole drilling using temporal graphs. An autonomous drill must be able to know what it is currently doing (which may be different than what it was told to do or what it thinks it is doing). This requires a lightweight method for extraction of informative features and a classifier method that can operate downhole on embedded hardware on the drill string. This invention presents a method of feature generation and state classification that employs only downhole data from a sensor array (e.g., multiple sensors, such as gyroscope, accelerometer, and magnetometer) and allows classification to be performed downhole on an embedded processor in the drill string; this avoids the need for expensive wired drill pipe and allows classification to be made much more quickly than if surface sensors were used.

(4.1) Method

(4.1.1) Sensor Data

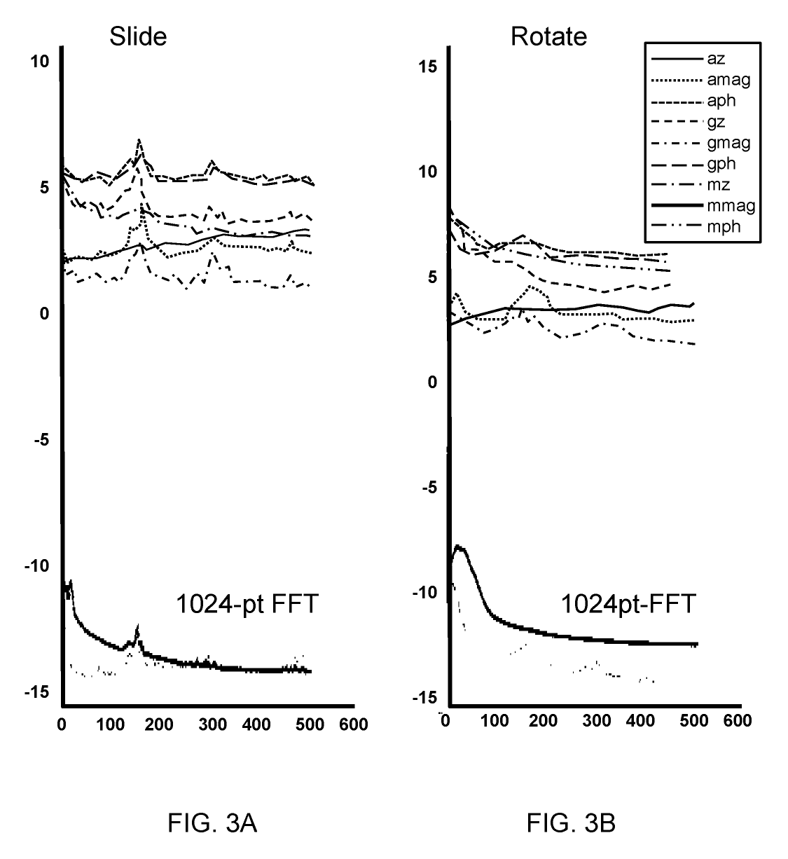

The system and method described herein uses any suitable sensor array. Desirably, the sensor suite or array includes a gyroscope, accelerometer, and magnetometer, each of which return information for three degrees-of-freedom (i.e., the x-, y-, and z-axes) for a total of nine signals. As shown in FIGS. 3A and 3B, depending on what the drill is doing, these signals may have different “shapes”. Specifically, FIGS. 3A and 3B provide a graphical comparison of Sensor Array Signals for “Drill Slide” and “Drill Rotate” States, respectively. A Fast-Fourier Transform over a ten-second window shows that during these different drilling phases, the signals produced by the sensors have different “shapes” in their spectra that can be used to identify the state.

An objective is to use the data from these nine signals to determine the current operating state of the drill (e.g., rotating, sliding, survey, trip, slip, etc.) so that the entire operation occurs downhole. For “ground truth”, any suitable historical sensor data may be used. As a non-limiting example, PASON state data is employed, which is information about the drill that is collected on the surface. The ground truth state data is used to create training data that associates the downhole sensor readings with a specific drill state. For example, the PASON state data is obtained from Pason, located at 6130 Third Street, SE, Calgary, AB T2H 1K4, Canada.

(4.1.2) Machine Learning

Machine learning manifests itself in two forms: unsupervised and supervised learning. Each has different uses and benefits. Unsupervised machine learning refers to a class of algorithms whose goal is to discover structure in unlabeled data and identify similarities and patterns between elements within the data. Within this mode of learning is clustering—the task of partitioning a collection of elements into sets in which the members of a single set resemble one another but differ from those in the other sets. Because clustering algorithms are not furnished with labeled examples, they are highly sensitive to the representation used for the input data. In the present system, the k-means clustering algorithm is used as a form of unsupervised learning, which logically sequesters similar data points into a fixed set of groups and can find hidden signals and structures within the data. For details on this algorithm, see the work of Bishop, Chapter 9 (see Literature Reference No. 2).

Supervised learning, in contrast to unsupervised learning, uses externally-determined labels to define the “ground truth” in a dataset. It is useful to think of this mode of learning as having a teacher who instructs the machine on the true classification of a feature (e.g., ‘true’ or ‘false’, ‘A’ or ‘B’, ‘slide drilling’ or ‘rotate drilling’) and the machine determines the appropriate association between the feature and the label. For supervised learning, the data is usually partitioned into a training set and testing set; the machine uses a prescribed learning algorithm, such as the support vector machine (SVM) to determine the relationship between the input features and the ground truth in the training set. Then, the performance of the trained algorithm is validated on the testing set; this is the generally-accepted way to evaluate the machine's ability to generalize never-before-seen data.

(4.1.3) Preprocessing the Training Data

The sensor suite or array data and the PASON state data must be cleaned and aligned before any feature extraction or learning algorithm can be applied. An objective is to assign a drill state from the PASON state data to every set of data points in the downhole sensor data. This process involves the removal of erroneous data such as sensor readings or PASON drill states that correspond to physically impossible configurations. Because a significant amount of the PASON state data appears to have been entered manually, some typographical errors and inconsistent shorthand must be corrected; for example, some misalignment is due to clocks/timestamps not being synchronized between the two data sets. The alignment process requires synchronizing the individual data streams from the sensor suite sensors with one another as well as aligning the temporal aspect of the sensor suite and PASON data sets. For example, this alignment can be done by an operator manually.

A final stage of preprocessing involves identifying the drill state for segments of the temporal data streams. This is accomplished by creating a decision tree with some hand-tuned threshold-based rules that ultimately give the “ground truth” labels, which indicate the state of the drill/rig (e.g., rotate, slide, reaming, survey, etc.) at any given time. These labels are assigned to the corresponding downhole data and subsequently used in supervised learning (classification) experiments and in the evaluation of unsupervised learning (clustering) experiments. This hand-labeling requires domain expertise; namely familiarity with the drilling process. For example, if it is observed that the drill is rotating and moving closer to the surface, than this would be identified as a “reaming” operation.

(4.1.4) Feature Extraction

(4.1.4.1) Experiment No. 1: Raw Data

As a first step, this task attempted to use the raw downhole sensor data as features that might be used as input to the machine learning algorithm. After the aforementioned pre-processing step, the data was fed directly into the training algorithm. Under this paradigm, the feature at a particular point in time is a nine-dimensional vector consisting of the readings from the x, y, and z-axis of the accelerometer, magnetometer, and gyroscope at that time. Machine learning on this data did not provide adequate separation of classes due to the high noise in the signal.

(4.1.4.2) Experiment No. 2: Spectral Features

After using the raw data to no avail and guided by the belief that the bulk of the information about the drilling states might be found by looking at the spectral content of the sensor data, this task examined the time-varying spectrum of downhole sensors using the short-time Fourier transform on data that fell within a temporal window of fixed width. The spectral analysis showed that the identification of the basic rotate and slide drill states was very easily discernable when only looking at the frequency data of the sensors; if so, then that information could be captured in a way that could be exploited by machine learning algorithms. In order to make the system operate in real-time (or at least quickly enough for the results to be actionable by the drilling personnel), the window width was restricted to values from several seconds to a few minutes. However, the results of this work show that these window sizes are too small for minimizing the effect of the noise present in the downhole sensor data.

(4.1.5) Solution: Temporal Graphs

After attempting to use the raw data and spectral representation to train a machine learning algorithm without success, attempts were made to employ temporal graphs to encode the sensor suite information. A network graph is a collection of nodes that are connected by edges, which provides a static snapshot of a group of entities and the relationships between them. The strength of the connection between any two nodes in the graph is indicated by the weight, which is some positive, non-zero value that increases with the strength of the connection between the nodes. A temporal graph extends the static graph structure in a way that is analogous to how a movie extends a photograph. In the temporal graph, the nodes do not change, but the edges between the nodes evolve over time at some update frequency; the connections between nodes may strengthen or weaken, or even disappear entirely. New edges can also appear between nodes where no connection has been seen before if a new relationship between the nodes is forged.

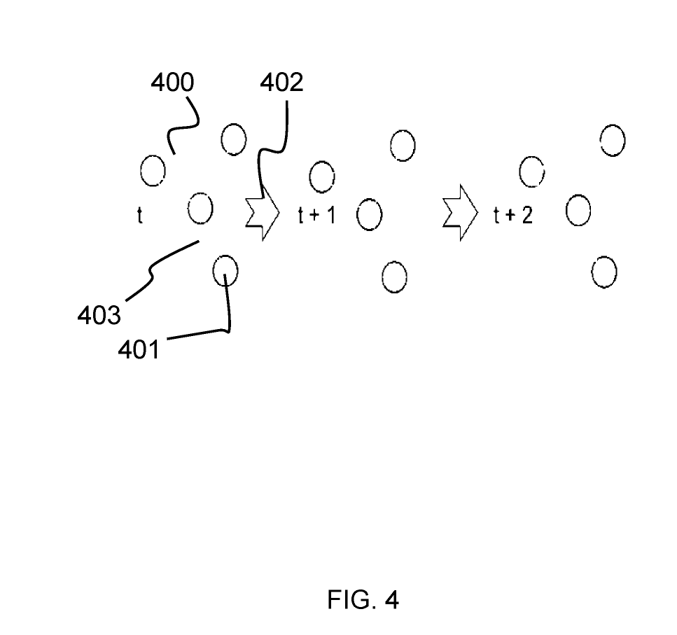

The description of the temporal graph is illustrated in FIG. 4. A graph G=(V, E) is a discrete object defined by a collection of nodes V and edges E⊆V×V that provide a static snapshot of a set of elements and the connections between them, which is represented as a nonnegative weight on each edge (u, v)∈E. The temporal graph extends the static graph 400 (with its nodes 401 and edges 403) by incorporating the element of time 402; let G=(V, E₁, E₂, . . . , E_{T}) denote the temporal graph obtained by “animating” a series of static graphs G₁=(V, E₁), G₂=(V, E₂), . . . , G_{T}=(V, E_{T}). wₜ(u, v) is used to denote the weight of the edge (u, v) for t∈{1, . . . , T}. Note that this representation uses a common vertex set V among all of the different values of Gₜ, such that only the edges change over time.

The system of this disclosure uses a temporal graph to represent the sensor suite sensor data by associating the degrees of freedom of each sensor (e.g., the x, y, and z-axis of the accelerometer, magnetometer, and gyroscope) with its own node in the graph, providing a total of nine nodes. The weight of an edge (u, v)∈Eₜ between any two of these nodes in the graph is defined by the statistical relationship between sensors u and v at a given fixed-width temporal window in the time series, which was experimentally optimized to a width of five seconds (although the invention is not limited thereto and can use any desired fixed-width temporal window). In this example, the optimal real time temporal difference between two adjacent static snapshots (i.e., the “framerate” of the movie) was determined to be 0.1 second, or 10 Hertz. The weights between the nodes in the temporal graph for a given time window are the features that are passed into machine learning. Finally, different functions for the weight wₜ (u, v) between two nodes were tested: covariance and mutual information.

Since the content of the signal from each of the sensors is not predictable at any given moment, one can consider them as “random variables” and define the weights between the nodes in the network graph by statistical metrics that quantify the relationships between two random signals. In this case, covariance and mutual information were tried as the edge weights to determine if these metrics can extract information about the drilling state that might be exploited by the machine learning algorithm. For reference, the variance of a signal is a representation of how much the individual measurements of that signal deviate from the overall average (mean) value of the signal. Therefore, the covariance metric is a way to measure how much a pair of signals jointly deviate from their respective means. The covariance between two signals, X and Y, is formally defined as follow:

cov(X,Y)=E[(X−E[X])(Y−E[Y])],

where E[.] indicates the “expected value” operator, which is conceptually similar to an average or mean (though not identical).

To determine the mutual information, the information of a single random variable must first be determined and then extended out. The information about a random variable X that occurs with probability p(X) is defined to be:

I(X)=−log(p(X)),

and is used to quantify the “unpredictability” of the random variable. Similarly, to how covariance extends the variance concept to multiple variables, the mutual information metric extends the concept of the information content of a variable (i.e., its “unpredictability”) to multiple dimensions, quantifying the information that is “passed along” from one signal to another. The mutual information between X and Y is defined as follows:

$$I ( X ; Y ) = {\sum }_{y ∈ Y , x ∈ X} p ( x , y ) log ( \frac{p ( x , y )}{p ( x ) p ( y )} ) ,$$

where p(x) and p(y) indicated the probability associated with variables x and y. To determine if covariance and mutual information encode any information about drill states, the k-means unsupervised learning algorithm was applied to the features to see if any patterns emerged.

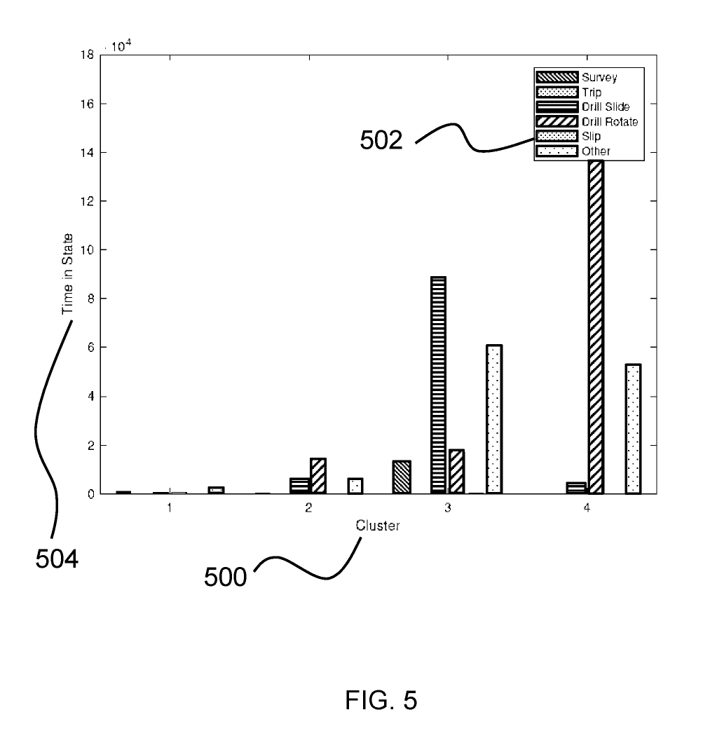

FIG. 5 illustrates the expressiveness of the temporal graph features by showing that the snapshots at each time step naturally cluster around prominent drill states. The histogram for each cluster (x-axis) 500 has a colored bar for each of the indicated drill states 502. The height of a bar corresponds to the number of points (i.e., the number of time steps) 504 that a given drill state is represented among the points for that cluster. Since k-means is an unsupervised learning algorithm, the propensity for each cluster to generally correspond with a single drill state shows that the feature vectors encode a fair amount of information about the drilling state on their own, and therefore should provide good classification power in a machine learning algorithm.

This method can be further extended by using the temporal graph to identify latent states in the data (i.e., states that do not directly correspond to drill states), and then building a Hidden Markov Model (HMM) for the observed (i.e., drilling) states, which allows better inference of the drilling state from the downhole sensor data. This HMM approach builds upon the existing approach in two important ways. First, clusters would no longer need to partition the set of drill states; instead, the mapping from cluster to drill state will be probabilistic (i.e., the emission probabilities). Second, temporal continuity between adjacent points will be preserved in the HMM.

(4.1.6) Training the Algorithm

To teach the algorithm to correctly to determine the drilling state from the sensor data, this system employs a multi-class version of the support vector machine (SVM). The standard SVM is a well-regarded and widely-used binary classifier that classifies the input into one of two classes but is a nonlimiting example of the type of classifier that might be used for this invention. However, this task requires an algorithm that can classify the input feature into one of multiple classes. Fortunately, there are a few ways to aggregate multiple binary classifiers into a single, multi-class classifier. One such method involves training a binary classifier to classify the input as being in a class or not in the class; this if often referred to as the “one-versus-all” method. The number of binary classifiers needed is equal to the number of classes in the overall problem. This aggregation of binary classifications can be viewed as a code, where only one binary classifier signals a positive value for each class. For example, with three classes, three classifiers (learners) are needed:

| Class | Learner 1 | Learner 2 | Learner 3 |
|---|---|---|---|
| A | 1 | 0 | 0 |
| B | 0 | 1 | 0 |
| C | 0 | 0 | 1 |

Another method involves training a classifier to classify one state against another (i.e., one-versus-one classifiers). Data points that belong to any other state are discarded for the training of the particular classifier. For N classes, this multi-class classifier trains a population of binary classifiers whose size is based on the number of combinations of pairs that can be taken from a population of size N. As in the previous case, this aggregation can be viewed as a coding of binary classifiers, albeit a generalized case where multiple binary classifiers may give a positive value.

| Class | Learner 1 | Learner 2 | Learner 3 |
|---|---|---|---|
| A | 1 | 1 | X |
| B | 0 | X | 1 |
| C | X | 0 | 0 |

The X in this table indicates that the learners are not trained with data points in that class. The multi-class decision is simply the sum of the three binary classifications (in this case: A=2, B=1, C=0).

Because of the coding nature of this multi-class classification, the methods are jointly referred to as error-correcting output codes (ECOC). It is possible to generalize to more learners and to design the codes to maximize performance in the non-ideal cases when a subset of the binary classifications have errors. For this work, the ECOC learning method using one-versus-one binary SVMs was implemented.

(4.2) Reduction to Practice

The straightforward method to evaluate the performance of the trained classifier is to test it on data that the learning algorithm did not see during its training. As mentioned previously, this involves partitioning the data into training and testing sets. Cross-validation is an improvement on this simple partitioning by dividing the dataset into equal parts, called folds, and iteratively testing on each fold after having been trained on the remaining folds in the dataset. Averaging the performance of the tests on each fold provides a better estimate of the generalization error when compared to the simple single training/testing partition. Bootstrapping is another method that samples the folds with replacement, allowing for more folds than a simple equal partition, as the folds may overlap. This work employed both bootstrapping and cross-fold validation to validate the training of the drill state classifier.

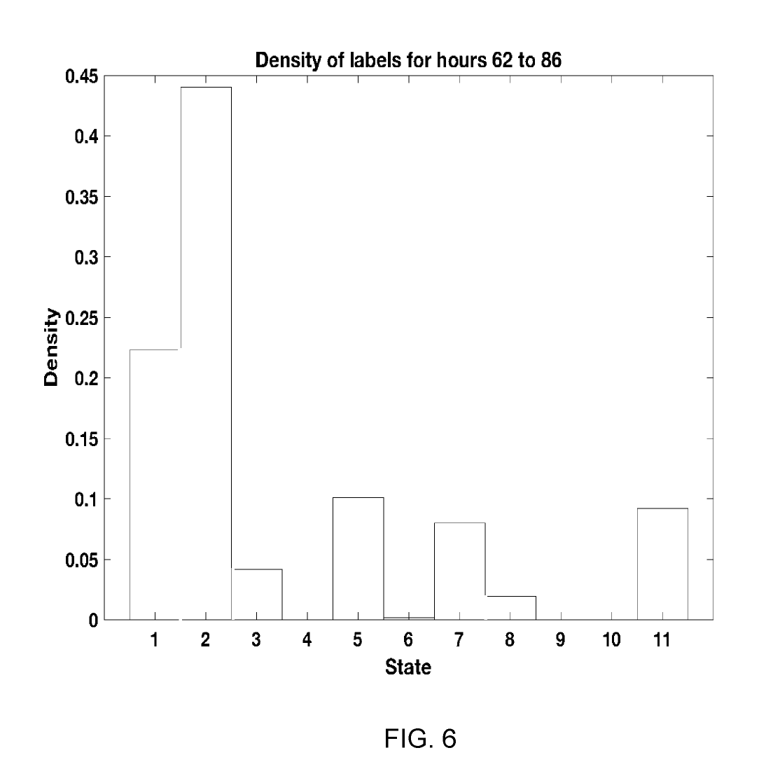

How well a classifier learns depends on the amount of data that is provided and how many degrees of freedom are available in the learning model. More “knobs” require more data to properly identify effects of each combination of settings. In view of simplifying the models, this work only trained on features from the selected sensor data that correspond to the four most dominant rig or drilling states (“slide”, “rotate”, “add pipe”, and “unclassified”) as labeled by PASON for the time window from 62 to 86 hours as shown in FIG. 6. FIG. 6 is a histogram of rig or drilling states, where to determine the drill states used for this experiment, 24-hours' worth of drilling data were looked at and the amount of time that was spent in each state (assigned integers along the abscissa) were computed, and the most commonly-occurring states, indicated by the numbers 1, 2, 5, and 11 correspond to “slide”, “rotate”, “add pipe”, and “unclassified”.

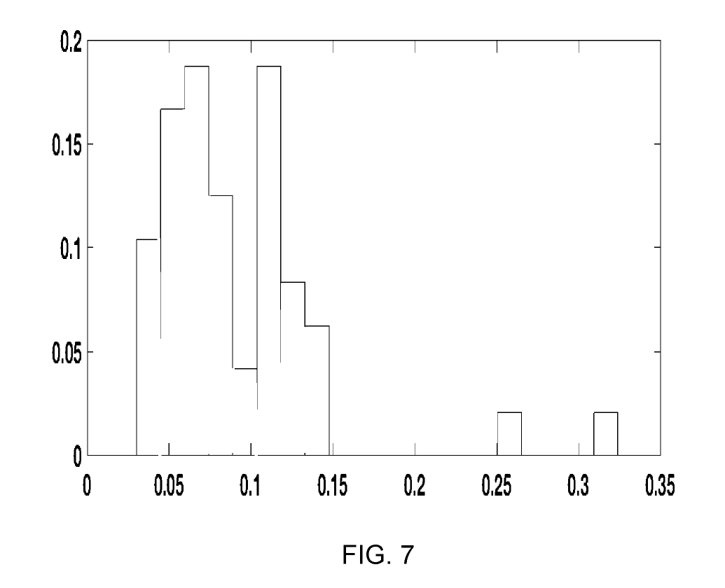

Preliminary results of training a multi-class ECOM SVM on the aforementioned drill states using the mutual information-based temporal graph as the features, shows an overall classification accuracy of about 85 percent. For further illustration, FIG. 7 is a histogram of classification errors in folds, where the classification errors in each of the folds in the k-fold analysis tends to be very low, holding at below 15% for the majority cases, and the most common error rate in the experiment is about 7%. The histogram of how each of the folds tested provides a better look at how the classifier generalizes. It should be noted that most of the folds exhibit between 10 and 15 percent classification error, where a few outliers skew the overall average performance. A possible explanation for the error is that the higher rate of making a classification compared to the PASON label states. The input data classifiers drill states once every second, but the classifier performs a classification every 0.1 second. It is conceivable that the actual drill state transitions occur between the one-second intervals, but the ground truth does not immediately show this transition.

(4.3) Offline and Online Components

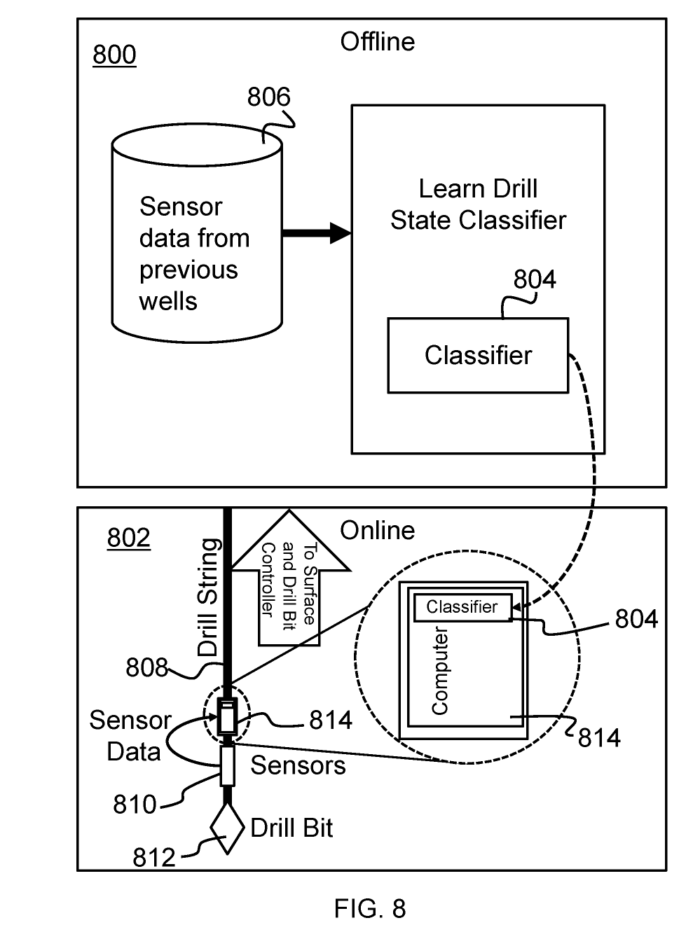

As shown in FIG. 8, the system described herein includes both an offline 800 and online 802 components. The offline component 802 includes pretraining the classifier 804 with historical sensor data 806 from previous drilling operations to create labels for drill states. During operation, a drill string 808 having a sensor suite 810 is activated to cause the corresponding drill bit 812 to begin and/or continue its drilling operations. A computer 814 having the classifier 804 is also mounted on the drill string 808 proximate the sensor suite 810 to receive sensor data from the sensor suite 810. Upon receiving online sensor data from the sensor suite 810, the computer 814 classifies the drill bit 812 as being in one of a plurality of pre-trained drill states based on the online sensor data. The classification can then be communicated to a drill bit controller that can alter or otherwise modify the performance of the drill bit 812 based on the classification.

(4.4) Control of a Device.

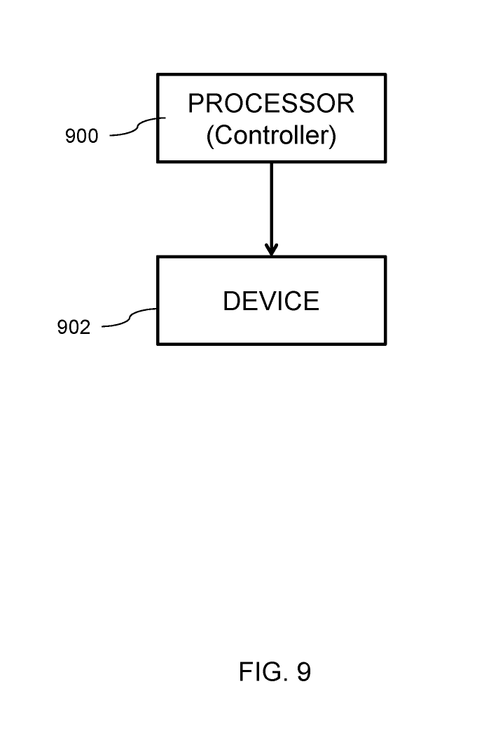

As shown in FIG. 9, a processor 900 (i.e., drill bit controller) may be used to control a device 902 (e.g., drill gear and corresponding drill bit) based on determining the drill state. The drill bit controller includes one or more processors and memory and any other suitable hardware and/or software as may be necessary to control a drilling operation of a drill bit as understood by those skilled in the art. The control of the device 902 may be used to cause the drill rig or gear to alter the speed, trajectory, or position of the actual drill bit. In other words, the drill bit controller modifies the operation of the drill bit based on the drill state classification. For example, if the drill state is at the bottom of the hole drilling and some anomalous thrashing is detected, this could indicate the early onset of a broken drill bit, in which case the drill bit controller could respond by pulling the drill bit up off of the bottom of the hole. As another example, if the classifier rapidly oscillates between multiple drill states at a rate much faster than an operator would willingly induce, this instability could be indicative of an impending hardware failure (e.g., a failing drill bit) in which case the controller could respond by pulling the drill bit up off the bottom of the hole and decreasing its rotational speed. Or, if bit-bounce is detected then the controller can adjust rotational speed and/or weight-on-bit to mitigate that behavior.

Finally, while this invention has been described in terms of several embodiments, one of ordinary skill in the art will readily recognize that the invention may have other applications in other environments. It should be noted that many embodiments and implementations are possible. Further, the following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. Further, while particular method steps have been recited in a particular order, the method steps may occur in any desired order and fall within the scope of the present invention.

What is claimed is:

1. A system for determining the current state of a drill using downhole sensors, the system comprising:
a computer mounted on a drill string, the computer having a trained classifier and being operable for performing operations of:
receiving online sensor data from a sensor suite mounted on a drill string proximate a drill bit; and
classifying the drill bit as being in one of a plurality of pre-trained drill states based on the online sensor data.

2. The system as set forth in claim 1, further comprising a sensor suite mounted on the drill string proximate the drill bit.

3. The system as set forth in claim 2, further comprising a drill bit controller, the drill bit controller having one or more processors and a memory, the memory being a non-transitory computer-readable medium having executable instructions encoded thereon, such that upon execution of the instructions, the one or more processors perform an operation of modifying the operation of the drill bit based on the drill state classification.

4. The system as set forth in claim 3, wherein the classifier is trained based on offline sensor data recorded from previous drilling operations, the offline sensor data being converted into offline temporal graphs.

5. The system as set forth in claim 4, wherein the online sensor data is converted into an online temporal graph, with the drill state being classified by matching the online temporal graph with a collection of similar offline temporal graphs.

6. The system as set forth in claim 5, wherein the online temporal graph is created by associating degrees of freedom of each sensor in the sensor suite with its own node in the online temporal graph, providing a total of nine nodes.

7. The system as set forth in claim 6, wherein edges exist between the nodes, such that weight of an edge (u, v)∈Eₜ between any two of the nodes in the online temporal graph is defined by a statistical relationship between sensors u and v at a given fixed-width temporal window in a time series.

8. The system as set forth in claim 1, wherein the classifier is trained based on offline sensor data recorded from previous drilling operations, the offline sensor data being converted into offline temporal graphs.

9. The system as set forth in claim 1, wherein the online sensor data is converted into an online temporal graph, with the drill state being classified by matching the online temporal graph with a collection of similar offline temporal graphs.

10. The system as set forth in claim 9, wherein the online temporal graph is created by associating degrees of freedom of each sensor in the sensor suite with its own node in the online temporal graph, providing a total of nine nodes.

11. The system as set forth in claim 10, wherein edges exist between the nodes, such that weight of an edge (u, v)∈Eₜ between any two of the nodes in the online temporal graph is defined by a statistical relationship between sensors u and v at a given fixed-width temporal window in a time series.

12. A computer program product for determining the current state of a drill using downhole sensors, the computer program product comprising:
a non-transitory computer-readable medium having executable instructions encoded thereon, such that upon execution of the instructions by one or more processors, the one or more processors perform operations of:
receiving online sensor data from a sensor suite mounted on a drill string proximate a drill bit; and
classifying, with a trained classifier, the drill bit as being in one of a plurality of pre-trained drill states based on the online sensor data.

13. The computer program product as set forth in claim 12, wherein the classifier is trained based on offline sensor data recorded from previous drilling operations, the offline sensor data being converted into offline temporal graphs.

14. The computer program product as set forth in claim 13, further comprising instructions for causing the one or more processors to perform an operation of converting the online sensor data into an online temporal graph, with the drill state being classified by matching the online temporal graph with a collection of similar offline temporal graphs.

15. The computer program product as set forth in claim 14, wherein the online temporal graph is created by associating degrees of freedom of each sensor in the sensor suite with its own node in the online temporal graph, providing a total of nine nodes.

16. The computer program product as set forth in claim 15, wherein edges exist between the nodes, such that weight of an edge (u, v)∈Eₜ between any two of the nodes in the online temporal graph is defined by a statistical relationship between sensors u and v at a given fixed-width temporal window in a time series.

17. The computer program product as set forth in claim 12, further comprising instructions for causing a drill bit controller to perform an operation of modifying the operation of the drill bit based on the drill state classification.

18. A method for determining the current state of a drill using downhole sensors, the method comprising an act of:
causing one or more processers to execute instructions encoded on a non-transitory computer-readable medium, such that upon execution, the one or more processors perform operations of:
receiving online sensor data from a sensor suite mounted on a drill string proximate a drill bit; and
classifying, with a trained classifier, the drill bit as being in one of a plurality of pre-trained drill states based on the online sensor data.

19. The method as set forth in claim 18, wherein the classifier is trained based on offline sensor data recorded from previous drilling operations, the offline sensor data being converted into offline temporal graphs.

20. The method as set forth in claim 19, further comprising an act of causing the one or more processors to perform an operation of converting the online sensor data into an online temporal graph, with the drill state being classified by matching the online temporal graph with a collection of similar offline temporal graphs.

21. The method as set forth in claim 20, wherein the online temporal graph is created by associating degrees of freedom of each sensor in the sensor suite with its own node in the online temporal graph, providing a total of nine nodes.

22. The method as set forth in claim 21, wherein edges exist between the nodes, such that weight of an edge (u, v)∈Eₜ between any two of the nodes in the online temporal graph is defined by a statistical relationship between sensors u and v at a given fixed-width temporal window in a time series.

23. The method as set forth in claim 18, further comprising an act of causing a drill bit controller to perform an operation of modifying the operation of the drill bit based on the drill state classification.
